(19) United States
(12) Patent Application Publication
(10) Pub. No.: US 2010/0051214 A1
(43) Pub. Date: Mar. 4, 2010

(54) MODULAR CUSTOMIZABLE PANEL WINDOW CURTAIN SYSTEM

(76) Inventor: Patrick Daly, Miami, FL (US)

Correspondence Address: William Propp, Esq., 8205 Santa Monica Boulevard, PMB1-245, West Hollywood, CA, 90046, US

(21) Appl. No.: 12/202,981

(22) Filed: Sep. 2, 2008

(51) Int. Cl. E06B 9/24; A44B 19/24

(52) U.S. Cl. 160/368.1; 24/381

(57) ABSTRACT

A series of modular fabric panels with edge zippers interconnect to form a modular window covering system custom fit by a user to cover windows of various sizes. Flexible zippers with removable zipper pulls and edge cover fabric over the zippers create a customized curtain which looks like a standard sewn seamed curtain.

This application claims priority to U.S. application Ser. No. 11/489,001 filed Jul. 19, 2006, the entire disclosure of which is incorporated by reference.

### TECHNICAL FIELD AND BACKGROUND

1. Field of the Invention

The present invention relates to window curtains and particularly to a modular customizable panel window curtain system comprising individual curtain panels which detachably connect to each other to form a custom curtain for a window having a custom width or length; the curtains are interconnected by means of zippers or other fastening devices.

2. Description of Related Art Including Information Disclosed Under 37 CFR 1.97 and 1.98

Numerous types of window draperies and curtains are sold by custom specialty shops and department stores, which usually ask the customer for window dimensions and then submit orders to factories or distribution centers where the products are made to a specific size. Not only must the customer make two visits to these outlets to obtain the product, the custom window curtains are relatively expensive and require a customer to wait a considerable amount of time to be fabricated particularly if there are many other orders for custom curtains.

Mass merchandisers also distribute window curtains. In many such outlets only stocked sizes are carried, because some windows, especially in newer homes and offices, are of standard dimensions. These window curtains are usually much less expensive than those obtained from custom outlets because of the economies realized from carrying a limited stock of sizes and because there are no sizing operations which must be performed on the products. However, this is not an option for windows of an uncommon size.

None of the prior patents provide modular customizable window curtains or drapes using interconnected panels as desired for different curtain configurations.

U.S. Patent Application #20050011618, published Jan. 20, 2005 by Kee, is for a fabric assembly for interior decoration. The fabric assembly contains a base fabric having a receiving section adapted to receive a removable fabric section; one or more removable fabric sections adapted to be interchangeably attached to the receiving section; and fastening means for attaching the removable section to the receiving section of the base fabric. The removable fabric section is affixed to the base fabric to create a decorative scheme, and the decorative scheme can be easily changed by replacing the existing removable fabric section with another removable fabric section. The interchangeability between different removable fabric sections provides consumers with more decorative options without increasing the cost of decoration.

U.S. Pat. No. 5,191,922, issued Mar. 9, 1993 to Wade, provides a two-on-one snap, self installing and supporting curtain and valance assembly. A self-supporting curtain and valance assembly is provided for direct mounting onto a single curtain rod or shower-bath support, installed in juxtaposition with a window, door, shower-bath area or the like. The assembly includes a curtain subassembly, functional in various configurations. The curtain has a number of first coupling subunits secured to the inside surface of the flap of the curtain. The flap has a number of second coupling subunits secured to its inside surface. The flap can be engaged and looped around a curtain rod or support and attached to itself by the first and second coupling subunits for self-supporting the curtain subassembly on the rod without the need for separate, independently added hooks or the like. The curtain has a plurality of third coupling subunits fixed to the outside surface of the flap. The assembly further includes a valance subassembly having a number of fourth coupling subunits attached to its inside surface, allowing the valance to be optionally attached to the curtain by coupling the fourth subunits of the valance with the third subunits of the curtain for self-support of curtain and valance on a single curtain support. The curtain has a porous trim section through which the third and fourth subunits couple; and a shear subassembly mounted over the curtain rod and pressed and molded between the first and second curtain subunits to support the shear within the curtain. Any of a various arrangement of coupling or securing means may be used to constitute the member, including, but not limited to nickel-plated brass snaps (sew on or machine stamped type), sizes 1, 2 or 3, with heavier materials or fabric requiring stronger or larger size snaps; various snap combination units, various button, zipper and/or Velcro securing means and other types of two-part attachment or coupling means or one-part and/or one-part, sub-united means.

U.S. Pat. No. 2,500,074, issued Mar. 7, 1950 to Hill, shows modular window curtains made up of a plurality of sections which are removably attached together along horizontal lines.

U.S. Pat. No. 6,192,965, issued Feb. 27, 2001 to Hinds, claims a zippered shower curtain comprising a valance, a curtain, and a zipper. The valance includes a plurality of spaced apart apertures allowing for suspension of the valance from a horizontally disposed rod by rings or hooks. The curtain is removably attached to the valance by the zipper allowing for the easy attachment or detachment of the curtain from the valance by the engagement or disengagement of the zipper teeth.

U.S. Pat. No. 5,915,442, issued Jun. 29, 1999 to Prosch, describes curtains and window shades. An alternate window shade represented in the FIGS. 22-24 comprises a curtain of a rectangular or square fabric which is detachably affixed with its upper border edge to a mounting track, which is advantageously achieved with the aid of a Velcro fastener tape-like connection. It is possible, however, for differently constructed detachable connecting means, such as e.g. button type connections, zipper closing connections or the like to be made use of.

U.S. Pat. No. 2,771,945, issued Nov. 27, 1956 to Wittrup, discloses a sectional shower curtain having zippers on adjacent vertical edges.

U.S. Pat. No. 6,394,168, issued May 28, 2002 to Zoboski, indicates a shower curtain assembly for easy mounting or dismounting relative to a shower rod, which includes a first shower curtain portion having short vertical side edges with top and bottom edges extending therebetween and defining apertures for hanging the first portion from a shower rod with hooks. A second shower curtain portion includes long vertical side edges with top and bottom edges extending therebetween. Fastener strips having rib and groove elements depend from bottom and top edges of the first and second portions, respectively. Each fastener defines a guide track. The assembly includes a slider formed to straddle the fastener strips and having guide members that cooperate with the guide tracks. A separator finger is disposed in the slider and is shaped so as to urge the rib and groove elements apart or together depending on which longitudinal direction the slider is moved.

U.S. Pat. No. 2,269,964, issued Jan. 13, 1942 to Watson, puts forth a draped curtain having twin curtains hung from their upper ends. The adjacent vertical edges of the curtains are provided with mating portions of a zipper fastener for allowing opening or closure of the draped curtain.

U.S. Pat. No. 6,459,033, issued Oct. 1, 2002 to Muller, concerns a removably mountable blind-type curtain which includes a plurality of blinds removably securable to a curtain support. One or more of the blinds have a solar module secured thereto for converting solar energy to other energy. The blinds are connected to one another in a cable-free manner. Each individual blind is removably couplable along its lengthwise extent with at least one neighboring blind, such as, for example, via a separable zipper.

U.S. Pat. No. 4,137,683, issued Feb. 6, 1979 to Pfeiffer, illustrates a decorative object that comprises a plurality of panels joined by slide fasteners, such as zippers. Surface ornamentation on the assembled panels may be continuous. Preferably, all of the panels are a single ply sheet of a woven fabric such as canvas. The decorative object is secured to support means.

What is needed is a modular interconnected panel curtain system customizable in different configurations with covered interconnections so that the finished assembled paneled curtain or drape appears to be a seamed curtain or drape custom fit to the window.

### BRIEF SUMMARY OF THE INVENTION

An object of the present invention is to provide a series of panels with attached zipper edges recessed within overlapping material so that the panels may be interconnected horizontally and vertically to form a single modular interconnected panel curtain system customizable in different configurations with covered interconnections so that the finished assembled paneled curtain or drape appears to be a seamed curtain or drape custom fit to the window.

A related object of the present invention is to provide mating zipper edges on both a vertical and a horizontal edge of the panel so that both the height and width of the curtains or drapes may be custom fit to the windows.

Another object of the present invention is to provide lightweight flexible zipper connections between panels so that the curtains or drapes hang normally resembling custom all fabric curtains or drapes.

One more object of the present invention is to provide removable zipper handles so that they do not hang down from the ends of the zippers and the zippers are not visible.

The present invention allows a user to make a series of standard curtain panels of various sizes into any of a variety of custom size curtain sizes without having to pay the price to make a custom curtain. Most stores sell a panel curtain that can only fit a small window. Usually the width of a curtain panel will not cover a glass sliding door, it is usually used as decoration without being able to close it (it hangs at each side of the door or window).

The present invention allows a user to make a modular panel curtain system—which can be added on to without looking like an add-on. Each panel of curtain would have a zipper or fastener at the vertical length of the panel; the panel can be zipped together to look like one curtain. The zipper pull that is used to hold the zipper to zip it up or down can be removable, so that it won't hang at the bottom of the curtain. The line where the zipper adds one panel to the other would look like a regular seam. This seem would be noticed on any curtain that has a seam on it, however it the curtain has a design, it may be undetectable to the eye. The zipper or faster would be made very light weight, so that is would not change the shape and flow of the curtain. With this idea, one could make a curtain with one length and any width.

The present invention can be changed for greater flexibility if the curtains have design, or various design pleats on a solid color curtain. The zipper or fastener could be made to add a piece to the curtain to change the length also without ruining the effect of the curtain hanging. So, these curtains could be made to any width and some predetermined lengths and still be standard with a custom fit.

The advantages of the present invention include:

1. A user can buy ready made curtains to fit windows of any length of window without having to spend a lot of money to make custom curtains.

2. A user can replace a part of the curtain if it gets ruined and not have to purchase an entire new curtain.

3. A user can buy black out curtains in panels also and attach them behind the curtains as a standard package.

4. The price of purchasing curtain panels is very economical next to custom curtains.

5. A user can install the curtain immediately when he/she purchases it and not have to wait a long period of time while they are made.

6. A user does not have the worries with the present invention as when he/she purchases a custom curtain if it is going to be short or too long. With the present invention, if the curtain is too short, a length panel may be added.

7. A user can have curtains with designs or pleats used for most all areas of the house, since each panel can have different lengths and any size width.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is an elevational view of the front of the curtain panels of the present invention aligned for assembly;

FIG. 2 is an elevational view of the front of the curtain panels of the present invention interconnected for use;

FIG. 3 is an elevational view of the front of the curtain panels of the present invention interconnected for use and shown as they would appear hanging up;

FIG. 4 is an enlarge partial elevational view of a bottom portion of a back of a curtain panel showing a section of the zipper with the removable zipper pull;

FIG. 5 is an enlarge partial side elevational view of a bottom portion of a back of a curtain panel showing a section of an alternate zipper with a permanently attached zipper pull which locks in an up position so that the zipper pull does not hang below the curtain;

FIG. 6 is an elevational view of the front of a series of curtain panels of the present invention aligned for assembly the panels having only side zippers to adjust horizontal width of the curtains;

FIG. 7 is an elevational view of the front of the curtain panels of FIG. 6 interconnected for use;

FIG. 8 is an elevational view of the front of the curtain panels of FIG. 6 interconnected for use and shown as they would appear hanging up;

FIG. 9 is an elevational view of the front of the curtain panels of the present invention having only one side zipper for end panels and only two zippers for a middle panel;

FIG. 10 is an elevational view of the front of the curtain panels of the present invention each having a side zipper and a bottom zipper for end panels and two side zippers and a bottom zipper for middle panels and attachable bottom fringe panels;

FIG. 11 is an elevational view of the front of the curtain panels of the present invention each having only one side zipper and a top and bottom zipper for end panels and four zippers including two side and a top and a bottom zipper for a middle panel and attachable top valence panels and bottom fringe panels.

### DETAILED DESCRIPTION OF THE INVENTION

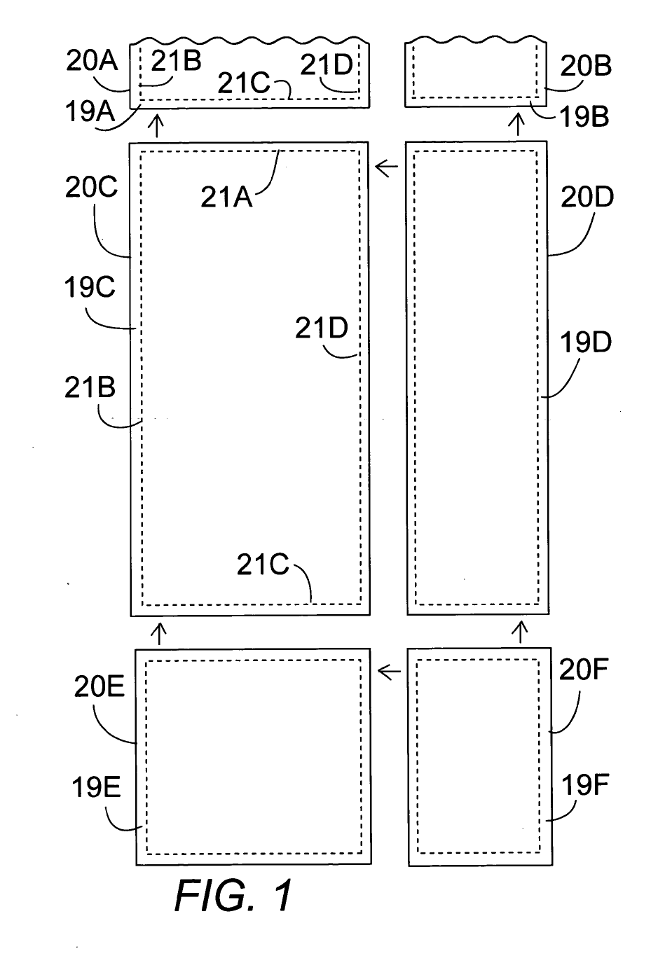

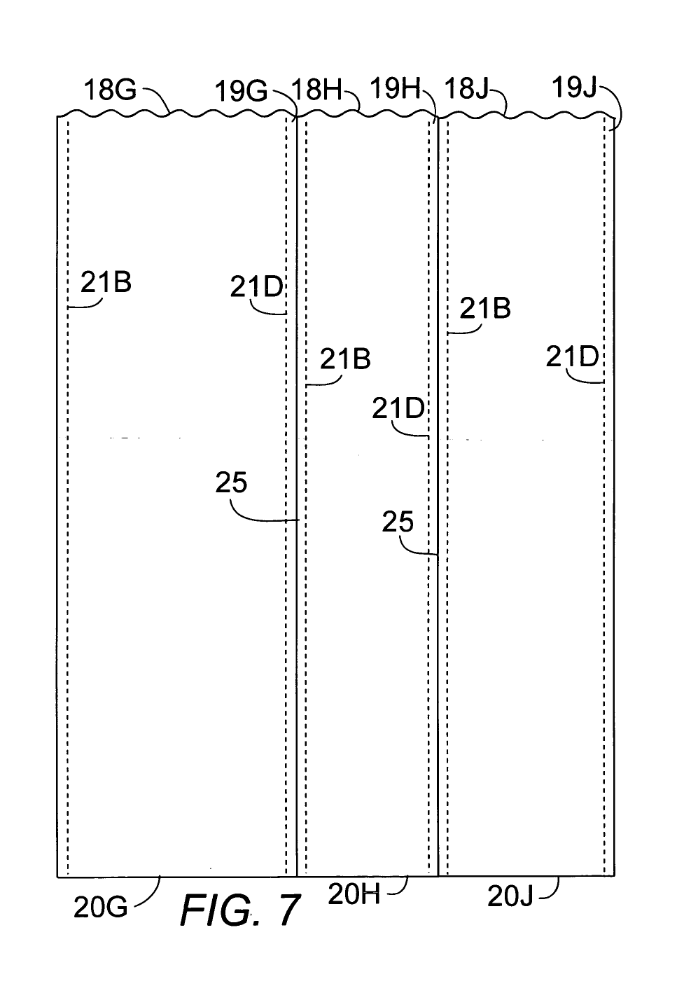

In FIGS. 1-11, a modular window dressing system of interconnectable fabric panels 20A-20H and 20J-20N and 20P-20X enables a user to construct a window dressing to cover a desired size window or sliding doors or other window type applications.

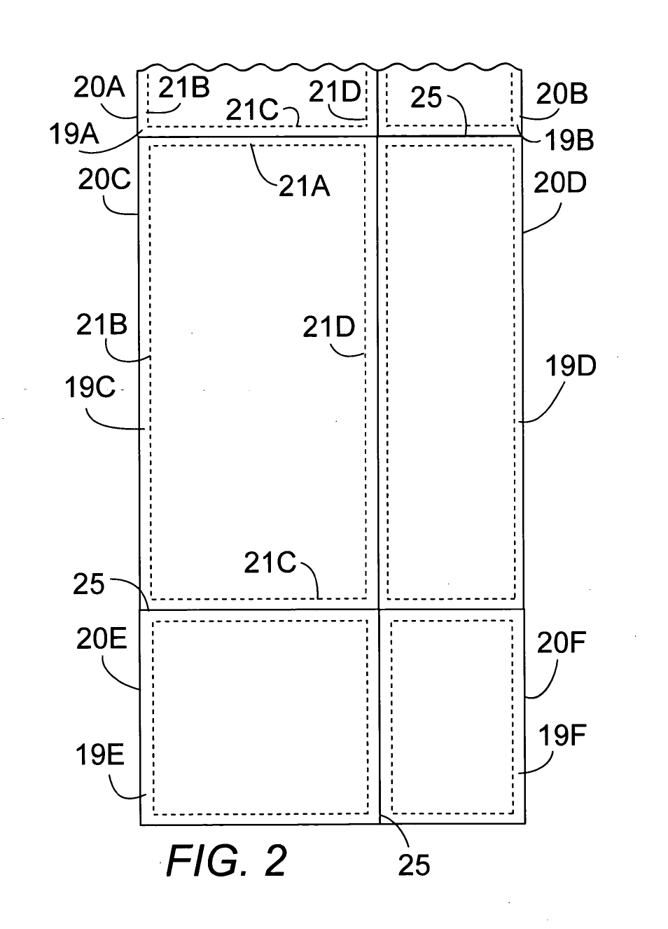

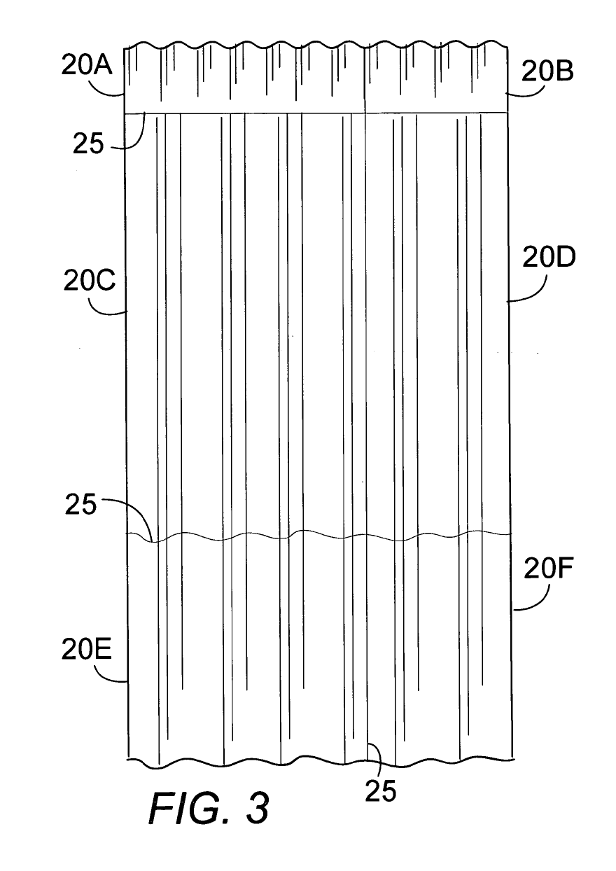

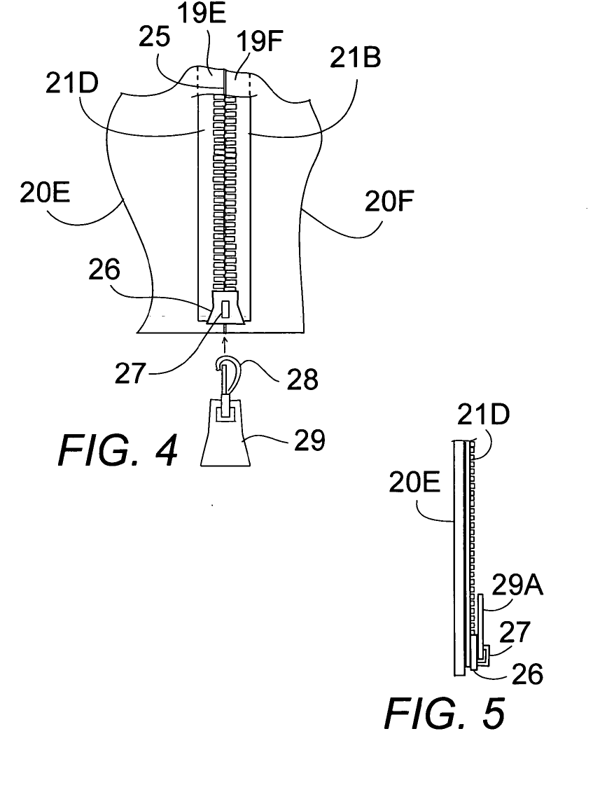

In FIGS. 1 and 2, a system of individual curtain panels 20A-20F each comprise a sheet of curtain fabric having a front side shown in FIGS. 1, 2, and 3, which faces into a room and a back side which faces a window, partially shown in FIG. 4. One side of a zipper connector 21A-21D is attached along an edge of the curtain panel on a back side of at least two edges, preferably 3 or 4 edges, of the curtain panel and a covering flap 19A-19F of material on the front side over the zipper along the length of each of the zippers covering the zipper from view on the front side with the covering flaps of material on adjacent interconnected panels contacting each other along an inter-contacting line 25 between panels to appear like a normal seam in a curtain, as shown in FIG. 3.

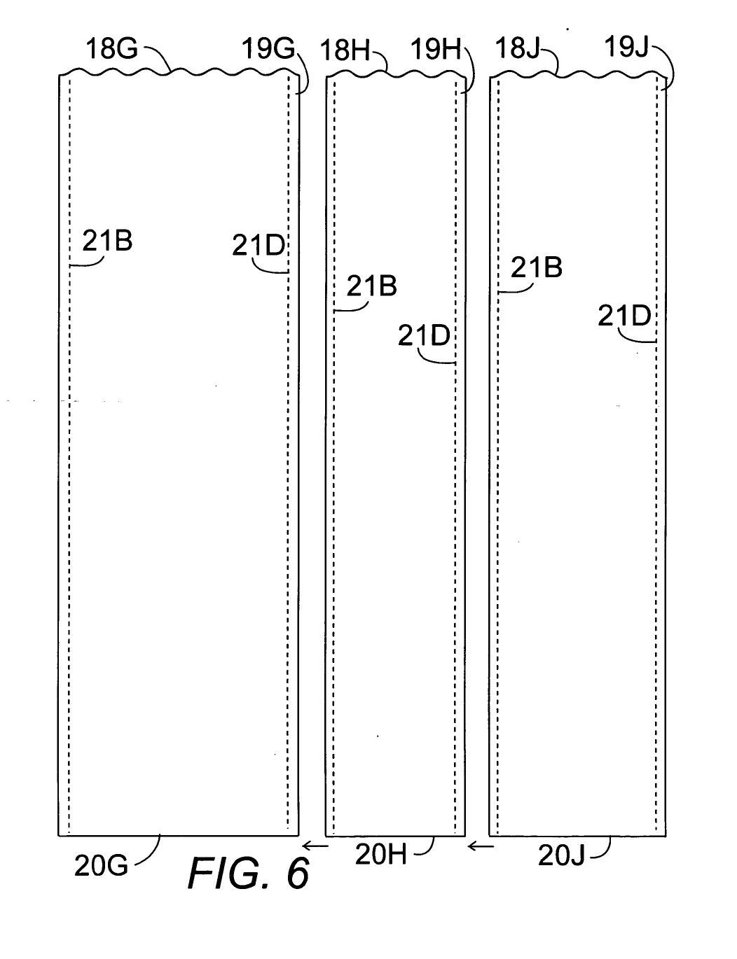

The zipper 21A-21D comprises a flexible lightweight zipper with a removable zipper pull 29, formed with a removable clip 28 which attaches to the loop 27 of the zipper closing and opening guide 26, as shown in FIG. 4, or a permanently attached zipper pull 29A which locks in an up position, as shown in FIG. 5, so that the zippers do not affect the appearance of the curtain formed by the assembled panels hang and the curtain hangs in a normal way without any visibility of the zipper, as shown in FIG. 3. The zipper may comprise a standard zipper with removable interlocking teeth fabricated of a lightweight flexible synthetic material or a zipper fabricated of a lightweight flexible synthetic material with one elongated tab on one panel removably locked into a mating elongated groove in an adjacent panel, as used on some plastic storage bags.

The panels 20A-20F detachably connect to each other to form a modular curtain system for a user to form a custom window cover for a window having a desired size custom width or length so that the finished assembled window covering appears to be a seamed window covering custom fit to the window. The panels are fabricated in a variety of sizes in rectangular (including square) shapes.

The system of curtain panels comprise at least one (and more as needed) valence panel 20A and 20B comprising a finished valence top edge 18A and 18B, one side of a zipper connector 21C attached to a bottom edge, and one side of a zipper connector 21B and 21D attached to each of two side edges of the at least one valence panel, and at least one curtain panel 20C-20F, and more as needed for adjustable sizing, comprising a rectangular sheet of curtain fabric having one side of a zipper connector 21B-21F attached to each of the four edges of each valence panel.

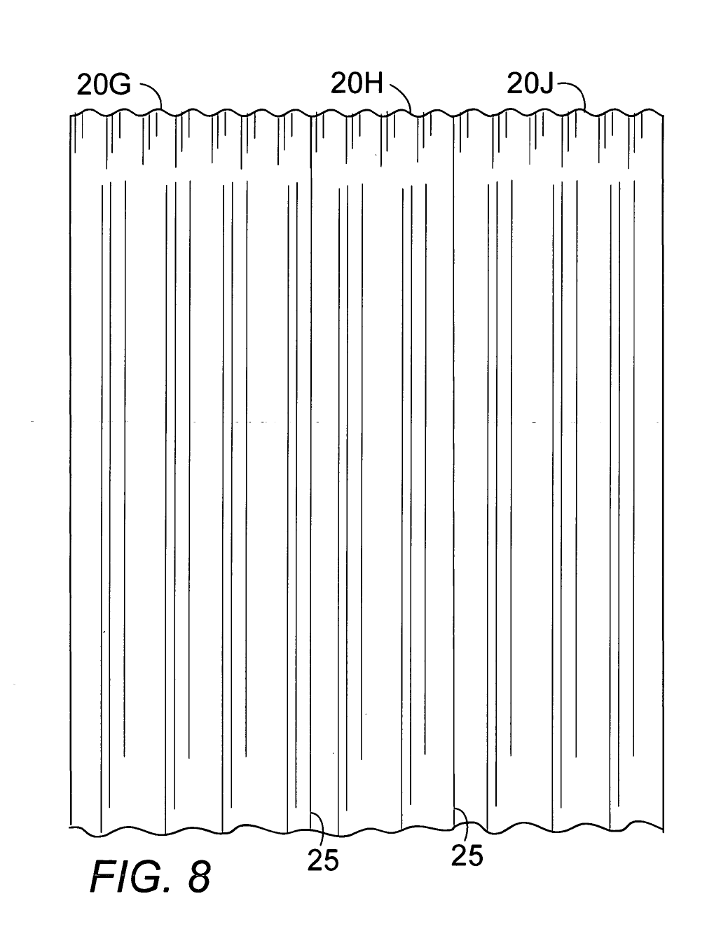

In FIGS. 6-8, a system of curtain panels 20G, 20H, and 20J each comprise only side zippers 21B and 21D so that the horizontal width of the curtains is adjusted as needed by adding panels together and the length is the same in all panels, which might be used for sliding glass doors or very tall windows or other application with a standard height window. The interconnecting lines 25 are all vertical and look like regular seems in stitched curtains, as shown in FIG. 8.

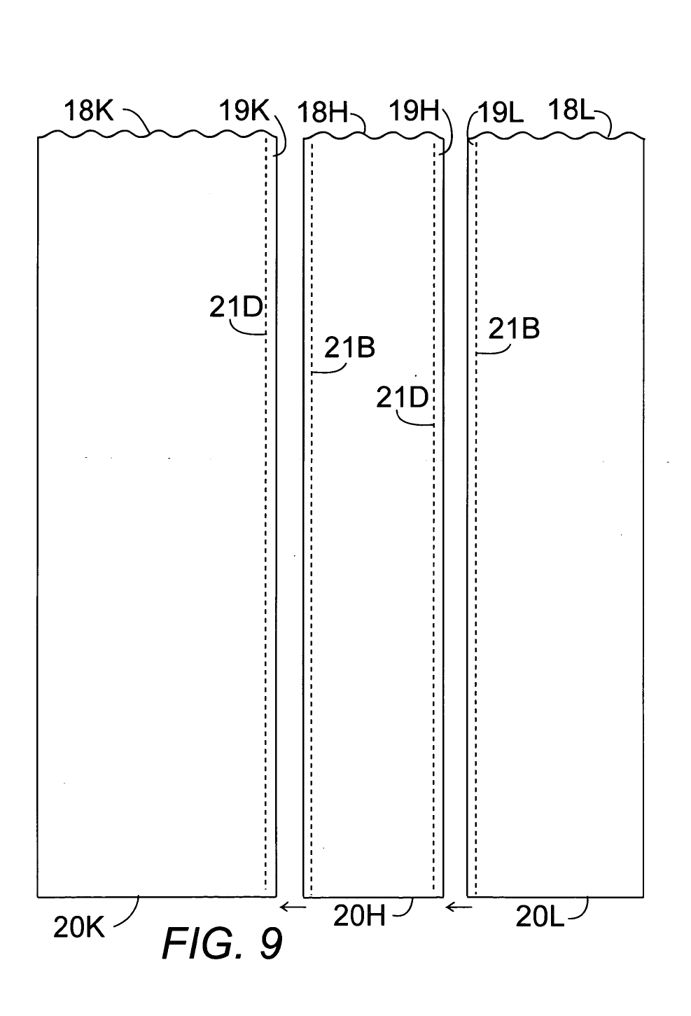

In FIG. 9, a system of curtain panels 20K-20L curtain panels have only one side zipper 21B and 21D, alternately a right and a left, for end panels 20K and 20L and only two side zippers 21B and 21D for a middle panel 20H, each panel having a built-in valence top 18K, 18H and 18L.

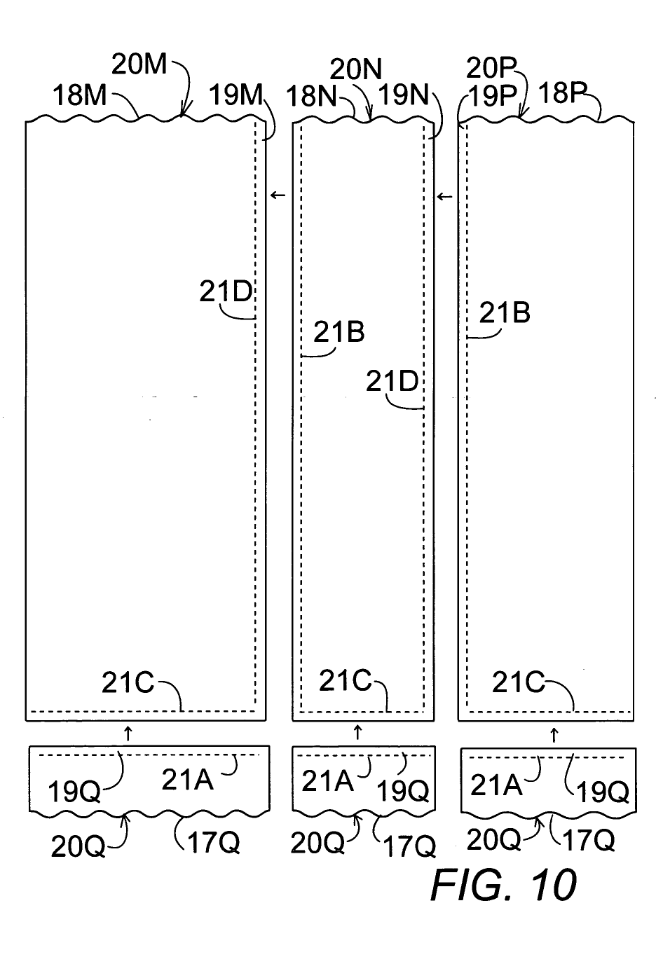

In FIG. 10, a system of curtain panels 20M, 20N, 20P, and 20Q each having a side zipper 21B and 21D alternately and a bottom zipper 21C for end panels 20M and 20N and two side zippers 21B Band 21D and a bottom zipper 21C for a middle panel 20Q and attachable bottom fringe panels 20Q each having a top zipper 21A and a bottom fringe 17Q.

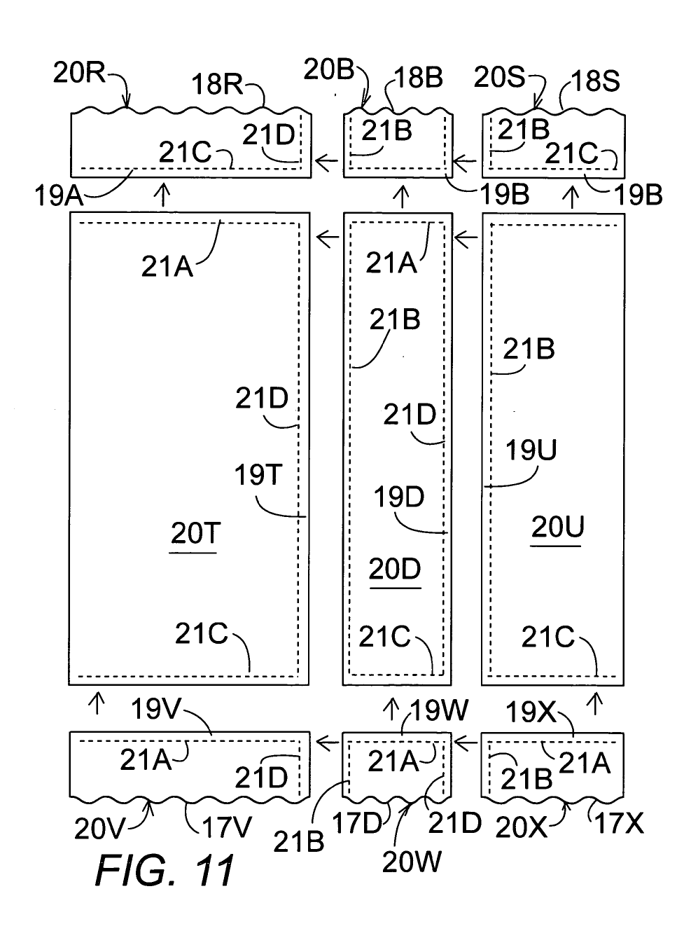

In FIG. 11, a system of curtain panels 20B, 20D, and 20R-20X each have only one side zipper 21B and 21D alternately and a top and bottom zipper 21C for end panels 20T and 20U and four zippers including two side 21B and 21C and a top 21A and a bottom 21C zipper for a middle panel 20D and attachable top valence panels 20B, 20R and 20S each with a top valence edge 18B, 18R and 18S, and attachable bottom fringe panels 20V-20X each with a bottom fringe 17V-17X.

As many panels may be interconnected by a user as are necessary to meet the needs of covering large or small windows, sliding glass doors, or any other situations. Special side panels and bottom panels may be fabricated without zippers on the outside and bottom edges respectively.

Curtain panels made with zippers only where needed for attaching to adjacent curtain panels save on costs of labor and materials as well as saving costs that might occur from wasted material if a mistake were made in installing an unnecessary zipper.

Differently colored and differently patterned and differently textured curtain panels including those with different valence and fringe styles provide for a large number of different curtain styles which are custom combined by users as well as different sizes to fit variously sized windows and provide whatever custom look a user desires.

In use, a series of fabric panels 20C-20F, each panel comprising a rectangular sheet of material for a window covering with attached zipper edges 21A-21D recessed within overlapping material 19C-18F, are interconnected by a user horizontally and vertically to form a single modular interconnected panel curtain and further connected to one or more valence panels 20A and 20B as needed for size to form a modular window covering system customizable in different configurations with covered interconnections so that the finished assembled paneled curtain or drape appears to be a seamed curtain or drape custom fit to the window, as shown in FIG. 3.

It is understood that the preceding description is given merely by way of illustration and not in limitation of the invention and that various modifications may be made thereto without departing from the spirit of the invention as claimed.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A modular window dressing system of interconnectable fabric panels to construct a window dressing to cover a desired size window comprising: a series of individual curtain panels, the panel is made up of two parts: a top panel and a bottom panel, which each comprise a sheet of curtain fabric having a front side which faces into a room and a back side which faces a window, one side of a zipper connector attached along an edge of the curtain panel on a back side of at least one edge of the curtain panel and a covering flap of material on the front side over the zipper along the length of the at least one zipper covering the zipper from view on the front side with the covering flaps of material on adjacent interconnected panels contacting each other to appear like a normal seam in a curtain, the zipper comprising a flexible lightweight zipper with a means for preventing the zipper pull from hanging down below the window dressing so that the zippers do not affect the appearance of the curtain formed by the assembled panels hang and the curtain hangs in a normal way without any visibility of the zipper, the panels detachably connecting to each other to form a modular curtain system for a user to form a custom window cover for a window having a desired size custom width or length so that the finished assembled window covering appears to be a seamed window covering custom fit to the window, all top panels are identical in construction and all bottom panels are identical in construction, the top and bottom panels do not have the same construction, the top panel comes in one length and the bottom panel comes in the same or different lengths to suit the window, all top panels having a lining, bottom panel optionally having a lining, all bottom panels are attached to the top panels by means of a horizontal zipper attached to the lining of the top panel, which is hidden by the front fabric of the top panel, the horizontal zipper on the top panel is attached to the lining, the slight stiffness of the zipper is hidden by the front fabric, so the natural fall of the curtain is not interrupted when the bottom panel is attached.

2. The system of claim 1 wherein the series of curtain panels comprise at least one valence panel comprising a finished valence top edge, one side of a zipper connector attached to a bottom edge, and one side of a zipper connector attached to each of two side edges of the at least one valence panel; and at least one curtain panel comprising a rectangular sheet of curtain fabric having one side of a zipper connector attached to each of the four edges of the at least one valence panel.

3. The system of claim 1 wherein the zipper comprises a zipper with removable interlocking teeth fabricated of a lightweight flexible synthetic material.

4. The system of claim 1 wherein the means for preventing the zipper pull from hanging down below the window dressing comprises a removable zipper pull which is unclipped and removed from the window dressing after assembly.

5. The system of claim 1 wherein the means for preventing the zipper pull from hanging down below the window dressing comprises a zipper pull which locks in an upright position against the closed zipper after assembly.

6. (canceled)

7. The system of claim 1 wherein vertical zipper pulls are hidden, if the panels are zipped from bottom to top, all horizontal zipper are hidden between the front and lining of the top panel, all vertical zippers are zipped from bottom to top, the zipper pull will end up at the top of the curtain when two or more panels, the zipper pull will hang down behind the curtain when not be visible from the front, the vertical zippers that are not attached to another panel are hidden by the fabric overlapping the zipper, these zippers that are not attached to another panel can be place on any area of the length of the side of the panel, they will not slide down, they must be physical pulled to move; they will not hang at the bottom of the curtain and become visible, horizontal zipper pulls are hidden between the front fabric of the top panel and the lining, the zipper pull will not be visible in any position.
